(19) United States
(12) Patent Application Publication
(10) Pub. No.: US 2006/0230171 A1
(43) Pub. Date: Oct. 12, 2006

(54) Methods and apparatus for decreasing latency in A/V streaming systems

(76) Inventor: Behram Mario Dacosta, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(21) Appl. No.: 11/104,843

(22) Filed: Apr. 12, 2005

(51) Int. Cl. G06F 15/16

(52) U.S. Cl. 709/231

(57) ABSTRACT

In audio-video (A/V) streaming systems, end to end latency is decreased with the goal to improve the user's viewing experience. Buffers in the server and client are flushed when a user initiates a change program signal. The client and server contain control modules to provide a flush buffer command. Latency may be further decreased by streaming initial segments of the data at a lower rate, and increasing the size of the buffers from an initial size to a maximum during streaming.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to A/V streaming systems, and more particularly to decreasing latency due to buffers in A/V streaming systems.

2. Description of Related Art

In a server-client A/V (audio-video or audio-visual) streaming system, the server streams video that is read from a source device, e.g. a hard-drive inside a personal video recorder (PVR). This A/V data is then transmitted to a remote client system, where the A/V data is output on a display device. In one particular application the client is located in the home environment, e.g. for entertainment or information systems. There are often multiple clients connected to one server.

The communication link between the Server and the Client may be based on powerline communications (PLC), wireless communications (e.g. 802.11), ethernet, etc. What such communication links have in common is that they introduce packet jitter and burstiness into the system. Such jitter and burstiness is introduced by various factors such as packet retransmissions and the nature of data transfer between various subsystem components. Packet jitter is the variance of the interval between reception times of successive packets.

The effect of this jitter on the display on the client would to be cause artifacts and other defects in the displayed video. In order to reduce the effects of this jitter on the perceived A/V at the client, systems typically include data buffers at both the transmitter (Tx) and receiver (Rx), and also at intermediate nodes on the network. Such data buffers are implemented in software or hardware or both. Multiple such data buffers may be used on each of the Tx and Rx. For example, at the Tx, the driver reading the stream off the source device (e.g. a hard-disk drive (HDD)) would have a data buffer, the software application would have a data buffer, the network protocol stack would have a software buffer, and the communication link (e.g. 802.11x) driver would also have a data buffer. On the Rx side there are similar buffers for the communication link (e.g. 802.11x) driver, the network protocol stack, the software application, and the video display driver. Even though data may be stored in such buffers with substantial jitter and burstiness, the data can be read from these buffers whenever required, and hence the output of these buffers is usually not affected by the jitter of the input data.

The problem with such data buffers or software and hardware buffers is that they also introduce a latency into the streaming system. Such a latency degrades the user experience in the following way. When the user at the client system clicks on the “play” button of the graphic user interface (GUI) on the screen to play a program off the HDD at the server, there is a delay before the video actually starts playing, providing the user with a decreased sense of interactivity. A similar problem exists when the user changes the viewed program. The existing data from the previous program that was previously in the buffers must first be streamed out and displayed on the Client display before the new program A/V data that has just been added to the end of the pipeline finally can be displayed on the client.

Thus the problem of jitter can be dealt with by introducing buffers but undesirable latency is thereby also introduced into the system. Therefore it is necessary to reduce latency to improve the viewing experience.

### BRIEF SUMMARY OF THE INVENTION

An aspect of the invention is a method for reducing latency due to buffers in an A/V streaming system, by streaming data into buffers in the A/V streaming system; holding streamed data in the buffers until removed; removing streamed data from the buffers for transmission or display; and flushing held data from the buffers in response to a change program command.

The method may further include sending initial segments of data from a source device to the buffers at a first rate, and sending the remaining segments of data from the source device to the buffers at a second rate higher than the first rate. The method may also include starting the buffers at an initial size when a program is first selected for viewing, and increasing the buffers as streaming continues until buffer size reaches a maximum.

Another aspect of the invention is a server-client A/V streaming system including a server, including buffers; a client, including buffers; a communications channel connecting the server and client; where the server and client each contain a control module which generates a flush buffer command in response to a user initiated change program command to flush the buffers in the server and client.

The communications channel is a wired or wireless channel. A source device is connected to the server, and a rate control unit may be connected to the source device. A display device is connected to the client, and a consumption control unit may be connected to the display device. The control module may also generate a buffer size control signal to increase the sizes of the buffers from initial sizes to maximum sizes.

A still further aspect of the invention is an improvement in a method for streaming A/V data from a source device to a server through a communication channel to a client to a display device through multiple buffers, comprising flushing the buffers in response to a change program signal to reduce latency. Further improvements include streaming initial segments of the data at a lower rate, and increasing the size of the buffers from an initial size to a maximum during streaming.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a Server—Client apparatus embodying the invention.

FIG. 2 is a flowchart of the basic method of the invention.

FIGS. 3-5 are flowcharts of additional methods of the invention.

### DETAILED DESCRIPTION OF THE INVENTION

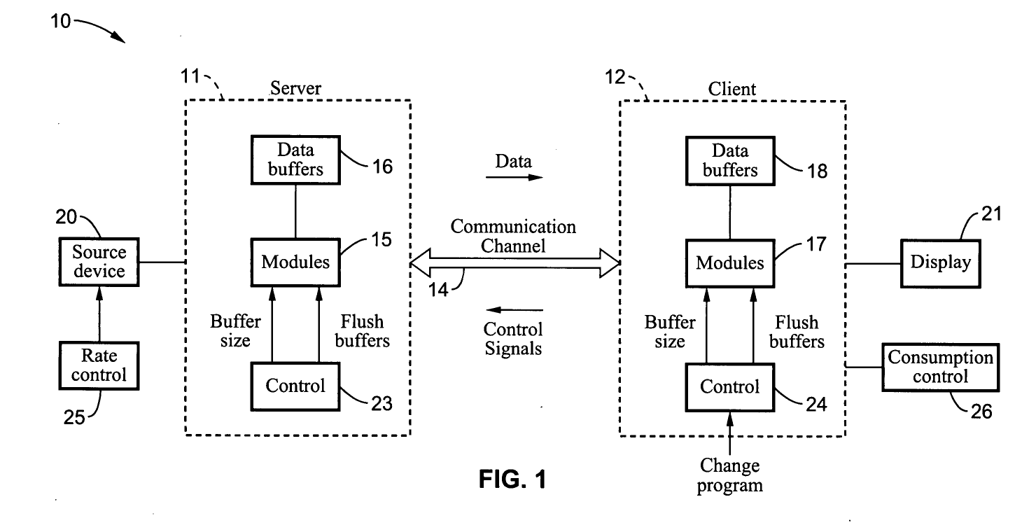

Referring more specifically to the drawings, for illustrative purposes the present invention is embodied in the methods and apparatus generally shown in FIG. 1 through FIG. 5. It will be appreciated that the apparatus may vary as to configuration and as to details of the parts, and that the methods may vary as to the specific steps and sequence, without departing from the basic concepts as disclosed herein.

The invention applies to a server-client A/V (audio-video or audio-visual) streaming system, e.g. a system where the client is located in a home environment. The server streams video that is read from a source and this A/V data is transmitted to a remote client system over a wired or wireless communication link. The communication link introduces packet jitter and burstiness into the system, which cause artifacts and other defects in the displayed video. Data buffers are included at both the Tx and Rx (and also at intermediate nodes) to reduce the effects of this jitter on the perceived A/V at the client. The buffers, however, introduce latency into the streaming system, which also affects the user's viewing experience. The invention is directed to reducing this latency.

FIG. 1 shows the basics of a server-client A/V streaming system 10, including a server 11 and a client 12. Server 11 and client 12 are connected together through a communication link or channel 14. Server 11 functions primarily as a transmitter to send A/V data to client 12 but can also receive information back from client 12. Client 12 functions primarily as a receiver of the A/V data from server 11 but can also transmit information back to server 11. Thus both are generally “transceivers”.

Server 11 contains a number of different modules 15 and associated data buffers 16. Client 12 also contains a number of different modules 17 and associated data buffers 18. As an example, modules 15 of server 11 may include a driver for reading the stream off a source device, the software application, a network protocol stack, and a communication link driver. Modules 17 of client 12 may include a communication link driver, a network protocol stack, the software application, and a video display driver. Buffers are associated with each of these components. The buffers may be implemented in either software or hardware or both.

The basic structures of servers and clients are well known in the art, and can be implemented in many different embodiments and configurations, so they are shown in these general representations of modules 15, 17 with buffers 16, 18. The invention does not depend on a particular physical implementation, configuration or embodiment thereof.

The server 11 streams video that is read from a source device 20, such as a hard-drive inside a personal video recorder (PVR). This A/V data is then passed and processed through modules 15 and buffers 16, and transmitted over communications channel 14 to a remote client system. At client 12 the A/V data is processed and passed through modules 17 and buffers 18, and output to a display device 21. Again, source devices and display devices are well known in the art, and will not be described further. The invention does not require particular source or display devices.

The communication link 14 between the server 11 and the client 12 may be wired or wireless. For example, link 14 may be based on Powerline communications (PLC), Wireless communications, ethernet, etc. Wireless communications may use IEEE standard 802.11x wireless local area networks (WLANs). Again, the invention does not depend on the particular technology used for the communication channel.

The most basic embodiment of the invention for reducing latency is the flushing of buffers. If a user is already viewing a program and then changes the program being viewed (e.g. using a “channel change” command), control commands are sent to the modules within the server and the client to flush the data buffers. This decreases the latency with which the user sees the new program on the client display.

The control commands are not usually delayed in their transmission across the communication link (i.e. they are not affected by buffer latency) for two reasons. First, the control commands (packets) are transmitted from client to server, not from server to client, and hence these “reverse direction” channel buffers are not normally full of A/V data when streaming is occurring from the server to client. Second, in such systems normally multiple priority queues are implemented. Hence the control commands would usually be assigned a higher priority than the A/V data, and hence use a higher priority queue with a smaller (or no) backlog of data waiting for distribution through the system. This buffer-flushing may be implemented as control messages sent from the client, or by commands/messages sent by the server when the program changes.

FIG. 1 shows the additional components used to implement the invention in server-client system 10. Server 11 and client 12 contain control modules 23, 24 respectively. When the user inputs a “change program” command into control module 24 of client 12, control module 24 produces a Flush Buffer command which is input to modules 17 and buffers 18 to flush the buffers 18 in client 12. Control module 24 also communicates over link 14 to control module 23 which inputs the “flush buffer” command to modules 15 and buffers 16 to flush the buffers 16 in server 11.

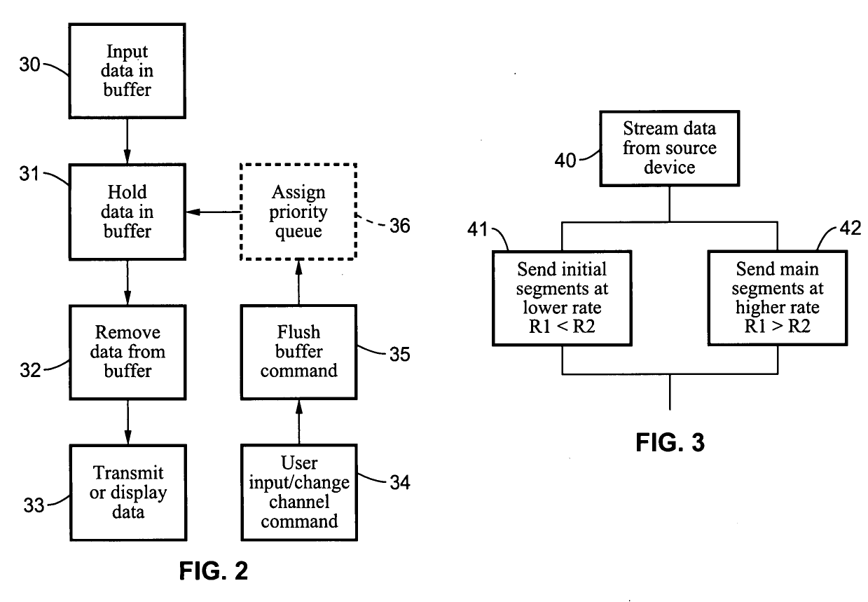

FIG. 2 is a flowchart illustrating this first method. Data is input into a buffer, step 30, where it is held, step 31, until it is removed from the buffer, step 32. The data removed from the buffer is either transmitted (from the server) or displayed (from the client), step 33. When the user initiates a “change channel” command, step 34, a “flush buffer” command is produced, step 35. The “flush buffer” command is used to cause data being held in the buffer (step 31) to be flushed. Optionally, the “flush buffer” command is assigned a priority queue, step 36, to prevent delays in its transmission.

Most buffers are implemented such that data contained within them can be read at any time, regardless of the amount of data in the buffer. However in some cases the buffer may be implemented such that the buffer accumulates data until it is full and only then it begins to output data (e.g. at a rate of one packet for every additional packet it receives) as in a FIFO. In this case, in addition flushing the buffers as just described, an additional method described below should also be implemented.

If it is desirable to further improve the performance of the buffer flushing method, and specifically to further decrease the latency, the initial segments of A/V data streamed are sent at lower A/V encoding quality. For example, if the main program is transmitted at data rates of 20 Mbps of MPEG-2 video, the initial segments are transmitted at a lower rate, e.g. 6 Mbps. This transrating of the A/V content can have been done prior to storing the content on the source device from which the streaming is occurring, or it can be done in realtime as the content is read off the storage medium. Hence each frame to be displayed comprises fewer bits, and can be transmitted and displayed with less delay.

This transrating process can be done by rate control unit 25, which is connected to source device 20 as shown in FIG. 1.

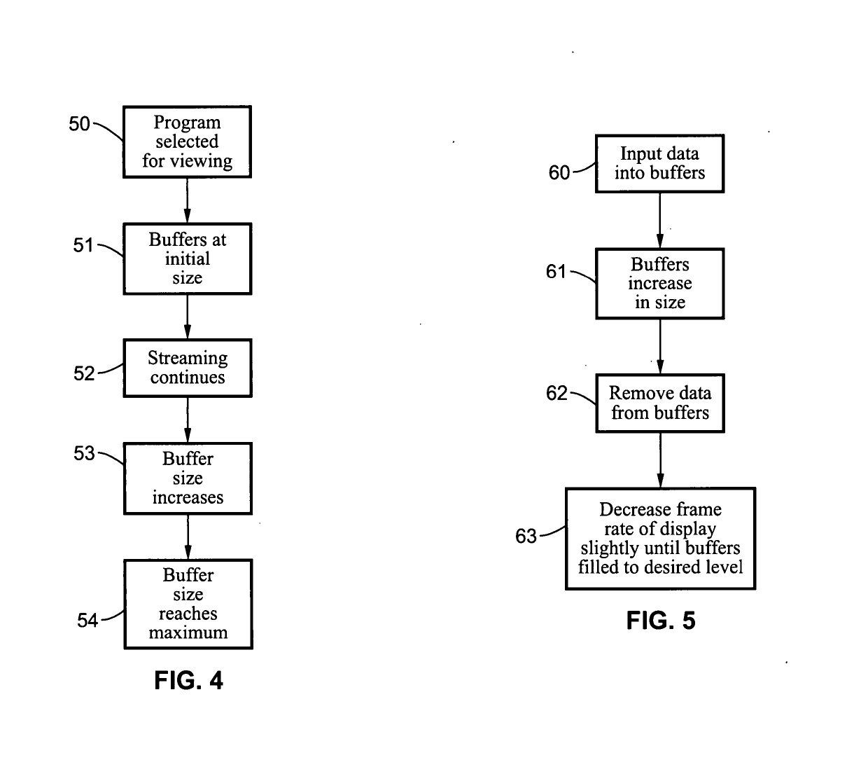

FIG. 3 is a flowchart of this second method of the invention. Data is streamed from the source device, step 40. The initial segments are sent at a lower rate, R1<R2, step 41. The main segments are sent at a higher rate, R2>R1, step 41. These segments can then be processed as before, e.g. stored in a buffer as in step 30 of FIG. 2.

In addition to the reasons explained above for FIFO type buffers, in some embedded systems is may be desirable to limit the amount of memory assigned to software buffers. In such cases an additional embodiment of the invention is implemented. When a program is first selected for viewing, buffer sizes are small. As the streaming continues, the buffer sizes are increased until the buffer size reaches the maximum desired buffer size. The maximum desired buffer size depends on the data rate and jitter, and is chosen to avoid buffer overflow and buffer underflow. As the buffer size is increased, the ability of the system to absorb jitter (due to packet retransmissions and other reasons) improves, helping to provide better quality of service (QoS) and hence video quality to the user viewing the client display.

FIG. 4 is a flowchart of this third method of the invention. When a program is selected for viewing, step 50, the buffers are at their initial (smallest) size, step 51. As streaming continues, step 52, the buffer size increases, step 53, until the buffer size reaches the maximum, step 54.

FIG. 1 shows the apparatus to carry out this additional embodiment of the invention. This additional feature may also be included in control modules 23, 24 in addition to the flush buffer feature. When a program is first selected, and during streaming, control units 23, 24 provide Buffer Size signals to modules 15/data buffers 16, and modules 17/data buffers 18, respectively, to control the initial size and increase in size of the buffers. Either control module 23, 24 can initiate the process, depending on where the Program Selection command is generated, and communicate to the other control module over the link.

An implementation of this invention, depending on which of the three methods of FIGS. 2-4 are implemented (any of the three can be used alone, but in the optimum/ideal case all three are used together), may require that either the rate of data inputted to the system (to the server from the content source) be controllable, or the rate of data consumption (at the display driver on the client) be controllable, or both. This is required to be able to help partially fill the client buffers that are gradually being increased in size, so as to help absorb the jitter. This is accomplished easily when the server is reading pre-recorded data, since then the data can be read at “faster than real time” until the appropriate amount of buffer has been filled. Such pre-recorded sources include PVRs, A/V HDDs, some video-on-demand (VOD) content from the content provider/intemet/headend, etc. For live programs it is not possible for the server to read the data ahead (into the future). In this case one option is to minimally and imperceptibly decrease the frame rate of the video being displayed on the client display, until the system buffers are filled to the desired level. At that point the frame rate may resume being the normal frame rate.

As shown in FIG. 1, Rate Control unit 25 controls the rate at which data is inputted to the system (to the server 11 from the content source 20). Consumption control unit 26, connected to the client 12, controls the rate of data consumption (at the display driver in the modules 17 on the client 12) to control the output to display device 21.

FIG. 5 is a flowchart of this additional feature of the invention. Data is input into buffers, step 60, the buffers increase in size, step 61, and date is removed from the buffers, step 62, as before. The frame rate of the display is decreased slightly until the buffers are filled to a desired level. As another example, If the (optional) flexible buffer sizes are not implemented, the buffer sizes remain fixed at some size; however, the rest of FIG. 5 remains the same, i.e. step 63 can be implemented without step 61. (The flexible buffer sizes are needed only if it is necessary to conserve memory resources on the server and client).

The invention reduces latency in an A/V streaming system and improves a user's viewing experience. When a user at the client clicks on the “Play” button of the graphic user interface (GUI) on the screen to play a program off the server, there will be less delay before the video actually starts playing, providing the user with an increased sense of interactivity. Similarly when the user changes the viewed program, there will be less delay before the new program starts playing.

The invention is not specific to home streaming systems, but may be applied to any streaming systems, including streaming over cell-phone links, cable links, WLAN, PAN, WAN, internet, etc.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for reducing latency due to buffers in an AN streaming system, comprising:
streaming data into buffers in the AN streaming system;
holding streamed data in the buffers until removed;
removing streamed data from the buffers for transmission or display; and
performing at least one of the following:
flushing held data from the buffers in response to a change program command;
sending initial segments of data from a source device to the buffers at a first rate and sending the remaining segments of data from the source device to the buffers at a second rate higher than the first rate; and
starting the buffers at an initial size when a program is first selected for viewing and increasing the buffers as streaming continues until buffer size reaches a maximum.

2. A method as recited in claim 1, comprising flushing held data from the buffers in response to a change program command.

3. A method as recited in claim 2, wherein the data removed from the buffers is displayed.

4. A method as recited in claim 3, wherein the change program command is initiated by a viewer watching the displayed data.

5. A method as recited in claim 2, further comprising generating a flush buffer command in response to the change program command and flushing the buffers in response to the flush buffer command.

6. A method as recited in claim.5, further comprising assigning a priority queue to the flush buffer command.

7. A method as recited in claim 1, wherein the data is streamed into the buffers of the AN system from a source device.

8. A method as recited in claim 1, comprising sending initial segments of data from a source device to the buffers at the first rate and sending the remaining segments of data from the source device to the buffers at the second rate higher than the first rate.

9. A method as recited in claim 1, comprising starting the buffers at an initial size when a program is first selected for viewing and increasing the buffers as streaming continues until buffer size reaches a maximum.

10. A method as recited in claim 1, comprising:
flushing held data from the buffers in response to a change program command;
sending initial segments of data from a source device to the buffers at a first rate and sending the remaining segments of data from the source device to the buffers at a second rate higher than the first rate; and
starting the buffers at an initial size when a program is first selected for viewing and increasing the buffers as streaming continues until buffer size reaches a maximum.

11. A method as recited in claim 3, wherein as data is removed from the buffers for display, the frame rate of the display is decreased slightly until the buffers fill to a desired level.

12. A server-client AN streaming system, comprising:
a server, including buffers;
a client, including buffers;
a communications channel connecting the server and client;
the server and client each containing a control module which generates at least one of:
a flush buffer command in response to a user initiated change program command to flush the buffers in the server and client; and
a buffer size control signal to increase the sizes of the buffers from initial sizes to maximum sizes.

13. A streaming system as recited in claim 12, wherein the communications channel comprises a wired or wireless channel.

14. A streaming system as recited in claim 12, further comprising a source device connected to the server.

15. A streaming system as recited in claim 14, further comprising a rate control unit connected to the source device.

16. A streaming system as recited in claim 15, wherein the rate control unit sends initial segments of data from the source device to the buffers at a first rate and sends the remaining segments of data from the source device to the buffers at a second rate higher than the first rate.

17. A streaming system as recited in claim 12, further comprising a display device connected to the client.

18. A streaming system as recited in claim 17, further comprising a consumption control unit connected to the client to control output to the display device.

19. A streaming system as recited in claim 12, wherein the buffers are at initial sizes when a program is selected for viewing and the buffers increase in size as data streaming continues until the buffers reach maximum sizes.

20. A streaming system as recited in claim 12, wherein the control module is a module which generates a flush buffer command in response to a user initiated change program command to flush the buffers in the server and client.

21. A streaming system as recited in claim 12, wherein the control module is a module which generates a buffer size control signal to increase the sizes of the buffers from initial size to maximum sizes.

22. A streaming system as recited in claim 12, wherein the control module is a module which generates a flush buffer command in response to a user initiated change program command to flush the buffers in the server and client, and a buffer size control signal to increase the sizes of the buffers from initial size to maximum sizes.

23. A streaming system as recited in claim 22, further comprising a rate control unit connected to the source device, wherein the rate control unit sends initial segments of data from the source device to the buffers at a first rate and sends the remaining segments of data from the source device to the buffers at a second rate higher than the first rate.

24. In a method for streaming AN data from a source device to a server through a communication channel to a client to a display device through multiple buffers, the improvement comprising at least one of:
flushing the buffers in response to a change program signal to reduce latency;
sending initial segments of data from the source device to the server at a first rate and sending the remaining segments of data from the source device to the server at a second rate higher than the first rate; and
starting the buffers at an initial size when a program is first selected for viewing, and increasing the buffers as streaming continues until buffer size reaches a maximum.

25. In a method as recited in claim 24, the improvement comprising flushing the buffers in response to a change program signal to reduce latency.

26. In a method as recited in claim 25, the improvement further comprising sending initial segments of data from the source device to the server at a first rate and sending the remaining segments of data from the source device to the server at a second rate higher than the first rate.

27. In a method as recited in claim 26, the improvement further comprising starting the buffers at an initial size when a program is first selected for viewing, and increasing the buffers as streaming continues until buffer size reaches a maximum.
